(19) United States
(12) Patent Application Publication
(10) Pub. No.: US 2008/0186415 A1
(43) Pub. Date: Aug. 7, 2008

(54) Curved screen display system and method

(75) Inventors: Andrew C. Boud, Alderley (AU); Alexander T. Streit, Leichhardt (AU)

Correspondence Address: COURTNEY STANIFORD & GREGORY LLP, P.O. BOX 9686, SAN JOSE, CA, 95157, US

(73) Assignee: AlphaCurve, Inc.

(21) Appl. No.: 11/818,663

(22) Filed: Jun. 14, 2007

Related U.S. Application Data
(60) Provisional application No. 60/814,175, filed on Jun. 16, 2006.
(60) Provisional application No. 60/844,624, filed on Sep. 13, 2006.
(60) Provisional application No. 60/930,626, filed on May 17, 2007.

(51) Int. Cl. H04N 9/31

(52) U.S. Cl. 348/744; 348/E09.025

(57) ABSTRACT

A curved screen display system and method are described. Embodiments include a processor coupled to receive standard video content, a light engine coupled to the processor, and an optics array positioned to receive a projected image output from the light engine, the optics array comprising a correction mirror configured to reflect the projected image onto a non-planar display screen accurately such that pixels of the projected image are remapped to the non-planar display screen. Embodiments further include a method for designing a correction mirror to display the standard video content on the non-planar display screen.

### RELATED APPLICATIONS

This application claims the benefit of U.S. Provisional Patent Application Ser. No. 60/814,175, filed Jun. 16, 2006, U.S. Provisional Patent Application Ser. No. 60/844,624, filed Sep. 13, 2006, and U.S. Provisional Patent Application Ser. No. 60/930,626, filed May 17, 2007, each of which is incorporated by reference in its entirety herein.

### TECHNICAL FIELD

Embodiments described herein relate to projection of video content onto screens of various non-planar configurations.

### BACKGROUND

Current display devices have predominantly been designed to present clear, bright, resolute imagery onto planar surfaces. This is especially true for consumer-level displays, which include traditional devices such as television display devices (CRTS, LCDs, Plasma displays, etc.), flat panel computer monitors, projection devices and the like. However, in certain visual applications, displays are curved. Areas where curved screens are used include cinematic displays, IMAX theatres, Flight Simulators, Visualisation Centres, and Planetariums.

An advantage of using curved displays is a wider field of view is seen when compared to planar displays. The degree of improvement, or increase in the field of view is partly a function of the depth of curvature of the display screen. In display devices where much larger fields of view are required to be filled, a single projection device is typically insufficient to provide a large enough field of view. To overcome this issue, multiple projection devices are often used to achieve the increased field of view. Flight Simulators, Visualisation Centres and Planetariums all offer a wider field of view than cinematic screens and as such, provide a much deeper curvature of the projection screen. Due to the differences of the displays, the overall specifications can change quite dramatically depending upon the exact nature of usage. As an example, a typical flight simulator may be designed to fill upwards of 160 degrees of the horizontal field of view by 40 degrees of the vertical field of view, whereas a Planetarium may provide up to 180 degrees horizontal field of view by 180 degrees vertical field of view. In the instances described where a larger field of view is required, typically the overall radius of the display device decreases, resulting in a much deeper curvature.

The use of multiple projectors to display an image over such a large field of view is complicated and expensive. The display must be divided into areas assigned to specific projectors that fill the required area of the screen. Then each projector must be aligned and matched to its neighbouring projection device. This requires some form of image correction for the curvature and shape of the screen, generally referred to as geometric correction. An overlapping region between projectors must also be defined. In this region, a technique known as edge blending is used to present a seamless image across the display. Edge blending uses an image mask to reduce the intensity of these overlapped regions to achieve a uniform image.

In addition to geometric correction and edge blending methods required for such systems, the content must also be made to match the exact details of the overall display and each individual projection device. The content is usually generated in several sections and displayed using a number of projection devices. As used herein, such content is referred to as “custom content” as it is specially generated to be displayed and matched onto a specific wide field of view display device. The sections are then combined, overlapped, and edge blended in order to present a seamless image across a screen with a wide field of view. Taking a six projector system as an example, six input signals are required from an image generator (usually some form of graphical computing device). Each graphical output must match the field of view of each projection device. Some form of geometric correction is then required to exactly align each individual projection device to achieve a seamless display.

One approach used for Planetarium based displays, is the use of a fish-eye projection lens. Here, only a single high resolution projection device is used with a custom modified fish-eye lens that matches the overall display system. This approach has the advantage of using fewer projection devices as the overall field of view is increased by the optical characteristics of the fish-eye lens. However, as only one projection device is used, the overall display resolution is limited by the use of just the one device instead of many. Also, as with the multiple projector-based approach, content must still be modified so that it is geometrically correct when played back through the fish-eye lens.

Currently available consumer-level curved display systems fail to effectively provide the desired visual effects using a single light source.

FIGS. 1-5 illustrate some disadvantages of current methods for displaying a projected image on a curved screen. FIGS. 1A and 1B show the mapping when an image is produced from a standard video projector and displayed onto a rear projection spherical or toroidal curved screen. The diagrams indicate the effects of the image size and mapping. FIG. 1A shows the projected image intersecting the top and bottom of the screen at the center points, while the horizontal width of the image is displayed beyond the edges of the screen. FIG. 1a shows this effect from a rear view and FIG. 1b shows the side view of the projection plane intersecting with a rear projected curved screen.

FIGS. 2A and 2B are diagrams showing the same effect as that presented in FIG. 1, but indicate what happens when the sides of the projected image are aligned to the edge of the display surface. Because the center of the screen is closer to the light source, the image plane is intersected before the virtual plane is projected onto. FIG. 2A shows a front view, and FIG. 2B shows a side view.

FIG. 3 is a diagram showing the area of image that is lost from mapping a planar image onto a rear-projected curved screen using non-optical methods. The shaded area shows the amount of pixels that are projected beyond the screen surface. This area will change depending upon the curvature of the screen, the native resolution and the native aspect ratio of the projected image. However, it is clearly shown that a significant proportion of pixel real estate is lost. With a general pricing trend that consumers pay higher prices for increasingly resolute devices, it is not desirable to throw this resource away.

Another undesirable effect when projecting a planar image onto a curved screen is perceivable distortion. FIG. 4 illustrates pincushion distortion. This occurs when images are projected from a planar projection device onto a curved (in this case spherical or toroidal) surface. This particular distortion effect is required to be applied when front projecting onto a concave screen, or rear-projecting onto a convex screen. FIG. 5 illustrates barrel distortion. This occurs when images are projected from a planar projection device onto a curved surface. This particular distortion effect is required to be applied when front projecting onto a convex screen, or rear-projecting onto a concave screen.

There is a need for an increased field of view display device that can enhance the viewing experience when using standard content that does not require the generation of custom content, or the use of multiple projection devices with geometric correction and edge blending techniques to provide a seamless overall image. There is a need for such an increased field of view display device that provides an enhanced viewing experience, yet can be produced economically such that a consumer could afford it.

### BRIEF DESCRIPTION OF THE FIGURES

FIGS. 1A and 1B show the mapping when an image is produced from a standard video projector and displayed onto a rear projection spherical or toroidal curved screen in the prior art.

FIGS. 2A and 2B are diagrams showing the same effect as that presented in FIG. 1, but indicate what happens when the sides of the projected image are aligned to the edge of the display surface in the prior art.

FIG. 3 is a diagram showing the area of image that is lost from mapping a planar image onto a rear-projected curved screen using non-optical methods in the prior art.

FIG. 4 illustrates pincushion distortion in the prior art.

FIG. 5 illustrates barrel distortion in the prior art.

FIG. 6 is a flow diagram of a method 600 for displaying standard content on a curved screen, according to an embodiment.

FIGS. 7A and 7B are diagrams of the mathematical relationship between points involved when rear projecting on-axis onto a concave cylindrical screen surface, according to an embodiment.

FIG. 8 shows a plot 800 of 20 by 20 points of C, calculated for a 1 meter tall screen with an aspect ratio of 16:9, where z is 2 meters, and r is 1 meter, according to an embodiment.

FIG. 9 is a block diagram of a curved screen display system 900 according to an embodiment, according to an embodiment.

FIG. 10 is a diagram of a system according to an embodiment.

FIG. 11 is a diagram of a rear projection curved screen display system showing an optical layout, according to an embodiment.

FIG. 12 is a diagram of a curved screen and a mirror 1210A, according to an embodiment.

FIG. 13 is a diagram showing parts of a Ray Model, according to an embodiment.

FIG. 14 is a diagram illustrating actual principal points and optimal principal points on a screen, according to an embodiment.

FIG. 15 is a diagram of a mirror including an illustration of a light cone-mirror intersection, according to an embodiment.

FIG. 16 is a diagram of a projector (also referred to as a light engine) projecting onto a curved screen, according to an embodiment.

FIG. 17 is a diagram of a projector (also referred to as a light engine) projecting onto a correction mirror, according to an embodiment.

FIG. 18 is a block diagram of a curved rear screen projection system, according to an embodiment.

FIGS. 19A and 19B are diagrams illustrating examples of pixel panel arrangements according to various embodiments.

FIG. 20 is a schematic diagram of a model of a lens arrangement, according to an embodiment.

FIG. 21 is a schematic diagram of an embodiment of a lens arrangement specifying dimensions, according to an embodiment.

FIG. 22 is a Zemax analysis of the model of FIG. 21.

FIG. 23 is a diagram of the physical shape change of a pixel panel to reflect a geometric correction map, where a geometric correction mapping function is calculated according to an embodiment

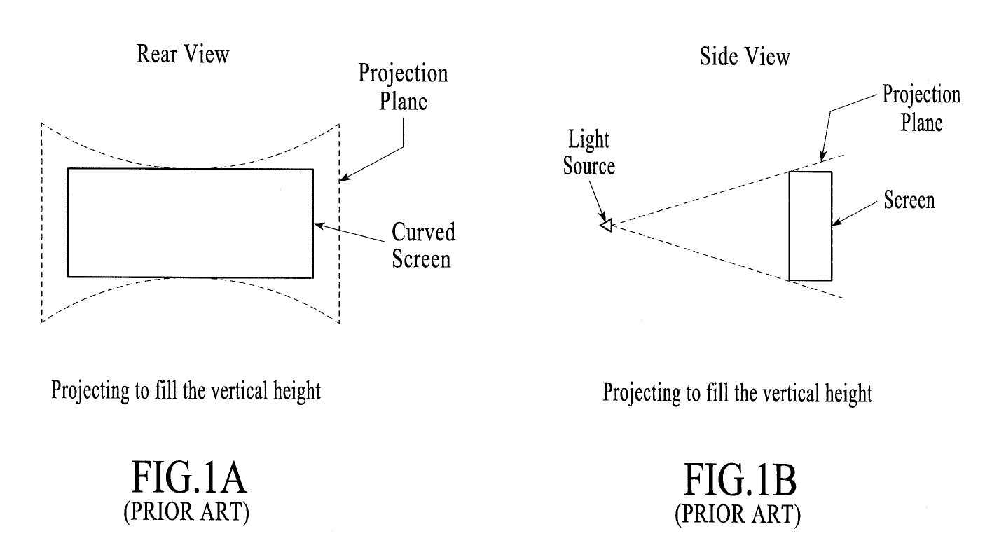

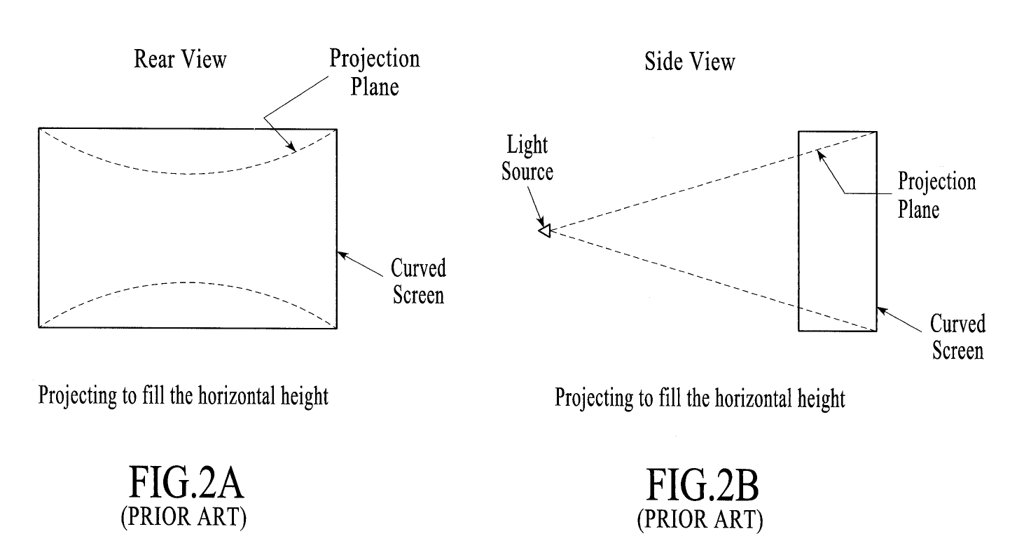

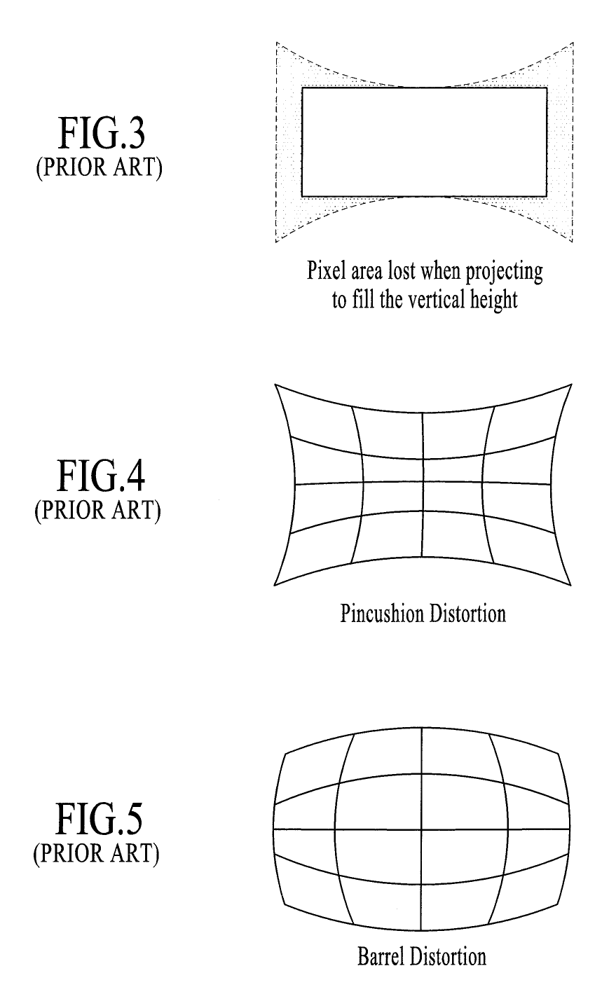

### DETAILED DESCRIPTION

Embodiments described herein include a curved screen display system and method that produces an increased field of view using standard source content. As used herein, standard source content (or standard content) refers to video content previously recorded and designed for display on a planar display device. Embodiments use standard content input to the system and method without requiring the content to have been specifically manipulated or designed for display on the curved screen display devices described herein. Embodiments include devices that can be produced economically enough to be available to home consumers, such as display devices for TV, computer devices, game consoles etc. In an embodiment, the display system includes a curved projection screen that is concave to the viewer. According to methods described herein, the curved screen is filled correctly and the viewer perceives no distortion.

According to various embodiments described herein, a standard content image is re-mapped so that it correctly fills the curved screen. This is referred to as being geometrically correct. The methods presented herein accept standard content as input signals, and no prior alteration of the input signal is required to achieve a geometrically correct image. The device uses a screen surface area that matches standard aspect ratios. Different devices provide different aspect ratios, physical sizes, shapes and radii of curvature.

Embodiments use a standard input signal (TV, DVD, Blu-Ray, HD-DVD, games console etc). In contrast to prior art methods, embodiments do not necessarily crop pixels. Native image resolution from the projection device is maintained. A wider field of is achieved by embodiments than is available in conventional planar-based displays. Content remapping as described herein is suitable for a variety of devices and need not be customized for various specific device applications.

By presenting standard content onto a curved screen device, the field of view is increased for a specified design eye point (DEP). The resulting effect of this change in the field of view is an improved sense of motion due to the improved coverage of the viewer's peripheral vision. Embodiments provide an overall heightened sense of immersion due to the improved field of view.

An embodiment includes a mathematical mapping function determined from physical characteristics of a projection display system. Once the mapping function is determined, it is used to achieve a geometrically correct image on a curved screen display device. An embodiment of the curved screen display system includes a conventional light engine (also referred to as a projection device or projector). The light engine can include fixed matrix light engines, laser light engines or other light engines used in planar display devices. The curved screen display system further includes a curved projection screen that is concave to the viewer. The curved projection screen may be of variable curvatures, physical sizes, aspect ratios and shapes (e.g., cylindrical, spherical, toroidal etc.). The mapping function is described for a cylindrical screen in a mathematically correct manner. However, this is just an example and other shapes are possible. According to embodiments, the projected image is further geometrically corrected so images are correctly mapped to the concave screen surface without loss of, or minimal loss of, image information. The image source can be any standard source with standard aspect ratios, such as TV, DVD, video, personal computer, games console, and other media forms.

Embodiments described herein allow the projection of standard content images onto surfaces of known characteristics. This is in contrast to prior art techniques that include methods to alter the geometry of projectors in situ to match a variety of screens shapes and sizes. In an embodiment, a curved screen of a known physical size, aspect ratio, and radius of curvature that is concave to the viewer is defined. A predetermined relationship exists between the light engine (also referred to as projector) location; light engine lens configuration, and screen surface configuration.

According to embodiments, a geometric mapping is generated depending upon the light engine (also referred to as projector) location; light engine lens configuration, and screen surface configuration.

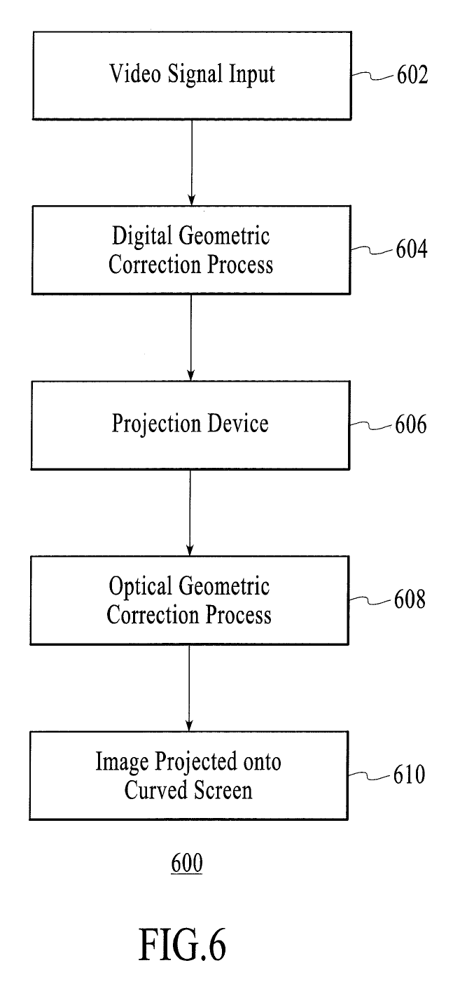

FIG. 6 is a flow diagram of a method 600 for displaying standard content on a curved screen, according to an embodiment. A video signal is input to the system at 602. At 604 a configurable digital geometric correction method is applied. The processor at 604 can be capable of standard functions of a processor coupled to a light engine (e.g. on-screen menu controls, scaler for non-native resolution inputs, zoom functions, crop, aspect-ratio conversion, focus control, etc.). In addition to any standard functions, the processor can also digitally correct the image for projection onto the non-planar screen, either in its entirety, or in conjunction with optical elements at 608. The processor at 604 can be used to fine-tune the correction and compensate for other issues such as projector drift. At 606 the projection device projects the corrected video signal, and at 608 the projected corrected video signal undergoes an optical correction process. The image is then projected onto the curved screen at 610.

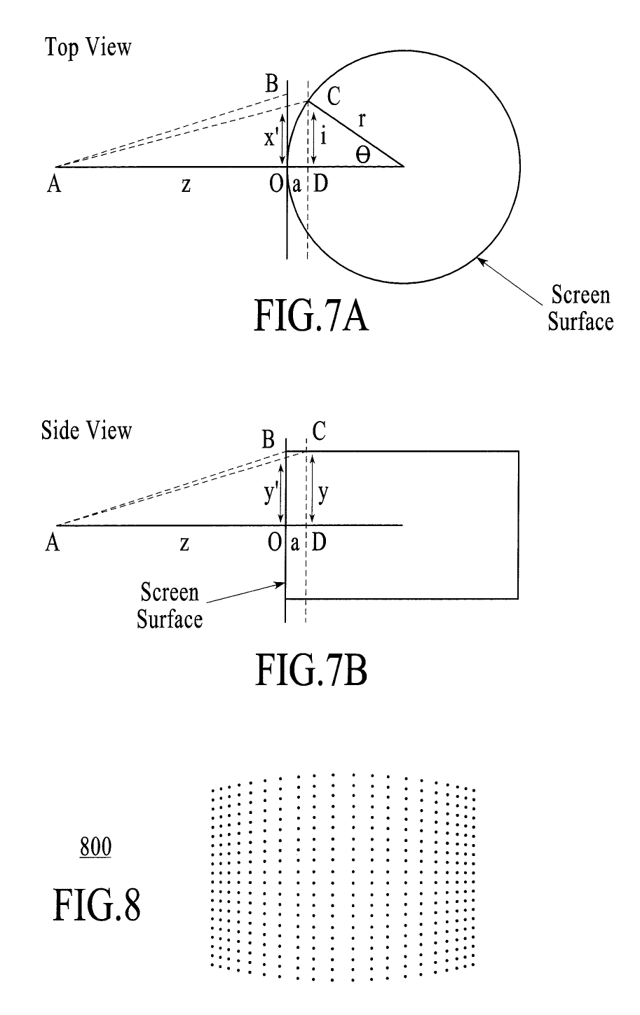

FIGS. 7A and 7B are diagrams of the mathematical relationship between points involved when rear projecting on-axis onto a concave cylindrical screen surface. FIG. 7A shows a top view of a cylinder whose outer circumference represents a screen. FIG. 7B shows a side view of the cylinder. A light source located at point A projects light rays at a plane located z units away. A light ray intersects the plane at point B, x units left/right of and y units above/below of O. Tangential to the plane is a cylinder of radius r. However, to correctly form an image on the surface of the cylinder, the light ray should hit the cylinder at point C. Point C is x units away from O along the circumference of the cylinder, i units to the left or right of the point D, and y units above or below the point D. The mathematical problem to be solved is finding point x′ and y, given x, y, z and r.

According to an embodiment, the solution is as follows:

A light source located at point A shoots light rays at a plane located z units away. Under a planar screen configuration, the light ray would intersect the plane at point B, x units left/right of and y units above/below of O. Tangential to the plane is a cylinder of radius r. The corrected light ray passes through the plane B at x′ units left/right of O and y units above/below O. The corrected light ray passes through the plane B to hit a point C on the cylinder.

Given x, y, z and r, find x′ and y′.

### SOLUTION:

Find the angle θ,

$$θ = \frac{x}{r}$$

Find a, the distance between O and D,

a=r−r cos(θ)

Find i, the distance between D and C,

i=r sin(θ)

Find x′,

$${x}^{′} = \frac{z}{z + a} i$$

Find y′,

$${y}^{′} = \frac{z}{z + a} y$$

Thus, we can find C,

$$C = [ \begin{matrix}{x}^{′} \\ {y}^{′}\end{matrix} ]$$

Which can be expanded out to

$$C = \frac{z}{z + r - r cos ( \frac{r}{x} )} [ \begin{matrix}r sin ( \frac{x}{r} ) \\ y\end{matrix} ]$$

FIG. 8 shows a plot 800 of 20 by 20 points of C, calculated for a 1 meter tall screen with an aspect ratio of 16:9, where z is 2 meters, and r is 1 meter.

Although a mathematical solution is presented above for rear projecting onto a cylindrical screen shape, there are a number of other significant factors involved with finding an overall solution for a suitable image shape depending upon the screen shape, the axis of projection, other optical elements placed in the path, etc. One example is provided herein, but in other embodiments these variables could be altered. Where this occurs, the techniques presented above can be mathematically adapted.

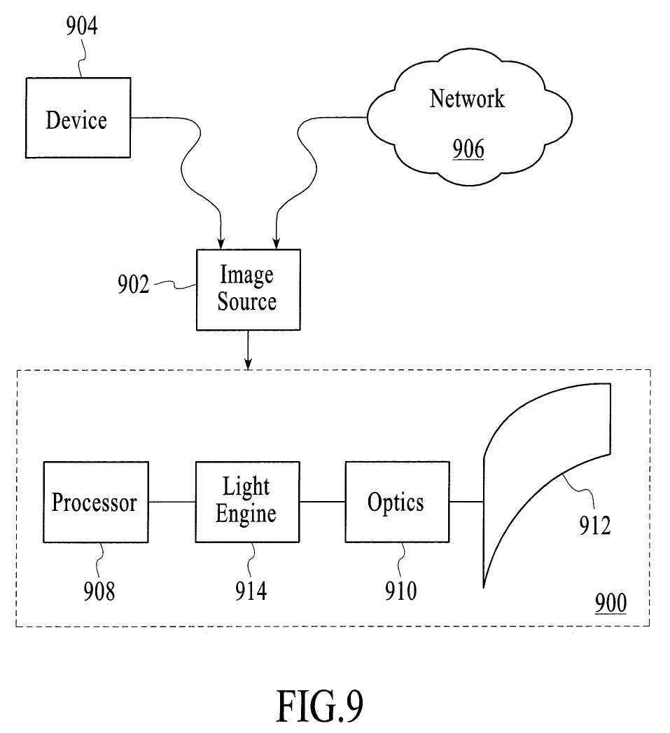

FIG. 9 is a block diagram of a curved screen display system 900 according to an embodiment. The system 900 receives standard content 903 from an image source 902. The image source can be any standard source with standard aspect ratios, such as TV, DVD, video, personal computer, games console, and other media forms. In various embodiments, the standard content 903 may originate from another device 904, or a network 906. The network 906 may be any kind of communication network capable of transmitting video signals. In various embodiments (not shown) the standard content 903 may be received by the system 900 directly from another device 904 or directly from the network 906.

The system 900 includes a processor 908, a light engine 914, optics 910, and a curved screen 912. The system 900 shows a rear projection arrangement. In various embodiments, the front projection systems are also contemplated.

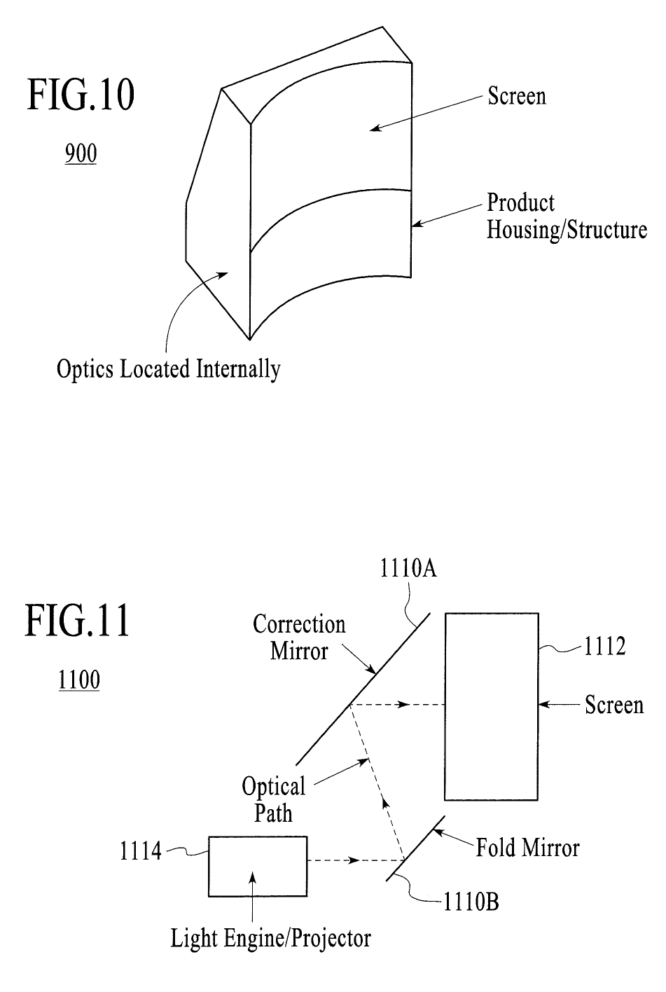

FIG. 10 is a diagram of a system 900 according to an embodiment.

FIGS. 11-15 illustrate an embodiment in which the optics 910 include a specially designed mirror in a rear projection system. FIG. 11 is a diagram of a rear projection curved screen display system 1100 showing an optical layout according to an embodiment. One possible representation of an optical layout of a curved screen display system is shown. In the optical layout shown, the system 1100 includes a light engine projection device 1114, a fold mirror 1110B, a correction mirror 1110A, and rear-projection curved screen 1112.

In an embodiment, the light engine 1114 includes a traditional planar based optical projection device as in current rear-projection televisions, and the correction mirror 1110A is specially designed according to embodiments as further described below. The light engine 1114 produces an image from a source input, which is projected onto the rear-projection curved screen 1112. Between the light engine 1114 and rear-projection screen 1112 is a combination of fold mirror/s and correction mirrors.

Fold mirrors are used in a number of projection technologies to reduce the overall throw distance of the projection device so that the overall size (depth) of the system is reduced. Fold mirrors are used in embodiments as a method to reduce the overall size of device. FIG. 11 shows just one such fold mirror, but multiple fold mirrors can be used in other embodiments to reduce the overall size of the system.

Correction mirror 1110A is used to produce a geometrically correct image that fills the projection screen correctly so that the viewer perceives no distortion. FIG. 11 shows one correction mirror, however, multiple correction mirrors can be used to reduce the amount of correction undertaken by one mirror. The correction mirror also folds the light path in order to reduce the overall depth of the device, hence, also acting as a fold mirror.

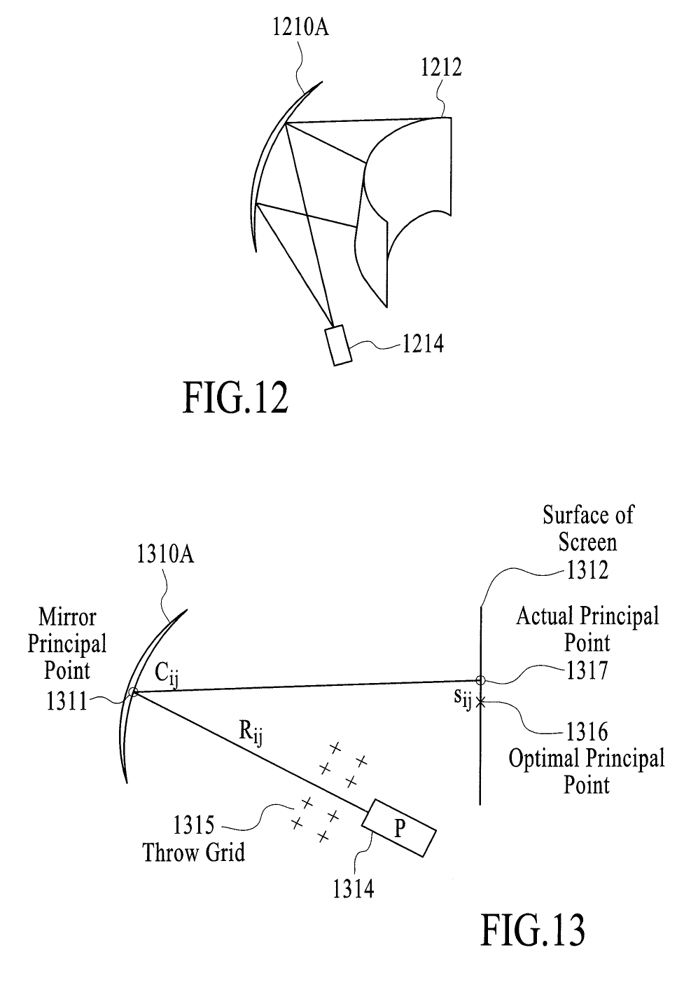

FIG. 12 is a diagram of a curved screen 1212 and a mirror 1210A. Characteristics of a mirror 1210A and a curved screen 1212 are used to perform the calculations shown above.

FIG. 13 is a diagram showing parts of a Ray Model. Rays are fired from a light engine 1314 through a throw grid 1315 to hit a mirror 1310A at a mirror principal point 1311. The rays reflected off the mirror hit a screen 1312 at an actual principal point 1317. An optimal principal point 1316 is the most desirable point for the ray to hit. Each ray will have its own mirror principal point, its own actual principal point, and its own optimal principal point. The mirror principal point and actual principal point depend on the shape of the mirror. The optimal principal point for each point is generated mathematically from the shape of the screen and does not depend on the mirror. As an example, the optimal point for the scenario in FIGS. 7A and 7B is the point D. The throw grid is an aid to calculating the rays that is derived from the light engine's characteristics (such as the projection device's optics, zoom settings etc.), and does not depend on the mirror surface or the screen shape.

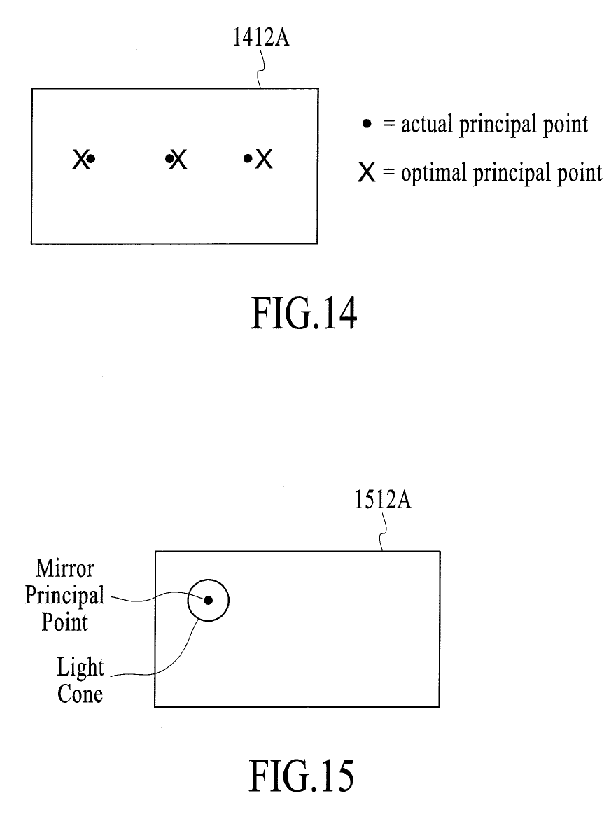

FIG. 14 is a diagram illustrating points on a screen 1412A that are actual principal points (marked with “X”) hit by rays. Also shown are and optimal principal points (marked with dots), which represent the ideal locations to hit. FIG. 14 illustrates that even through the right hand X and the left hand X are not hitting their corresponding dot points, the distance between subsequent Xs is even. This is more desirable than having a sudden jump in the distance between Xs.

FIG. 15 is a diagram of a mirror 1512A including an illustration of a light cone-mirror intersection. This shows that the intersection of the light cone and the mirror is an area.

The curved screen display system of FIGS. 11-15 is a single integrated device using a single light path and a single light engine. A mirror is specially designed to achieve accurate projection onto the curved screen. Deriving a suitable shape for the mirror involves calculations as described below.

Considerations in the design of the mirror include correction, transport, and focus. Correction is the process that ensures the light rays hit the correct points on the screen, given the unique shape of the screen. Transport covers non-correction related issues of getting the light rays to hit the screen, such as wide-angle lenses, etc. Focus refers to ensuring the image is correctly focused at the screen.

As described previously, the system consists of at least one light engine and a single screen surface. There may optionally be other elements in the light path, such as optical lenses and planar fold mirrors. The mirror embodiment as described above adds at least one correction mirror surface into the light path.

The following is an example of a single light engine and single correction mirror surface. Multiple mirror surfaces and light engines are an extension of this method.

Given a screen surface, S, and a light engine at location p, we need to find a surface, C, such that light is correctly reflected from the light engine back onto the screen. The definition of “correctly” includes correction, transport, and focus characteristics. Due to the nature of the problem, including numerical and manufacturing precision issues, it is not always possible to produce a “perfect” mirror surface. Therefore optimization algorithms can be used to provide a best fit solution. We first describe the problem under idealized conditions and then consider the optimization problem.

Ray Model

With reference to FIG. 13, a light engine at location p 1314 is able to generate a light ray Rᵢⱼ whose source is p and which represents the light engine space coordinates (i,j). One method is to use a model of the light engine that consists of a point light source and a throw grid (1315). The throw grid is a grid of points through which a light ray emitted from the light source will travel. The coordinates of the point within the grid correspond to the coordinates of the light ray in the coordinate space of the light engine. The grid is used to calculate the rays.

For every Rᵢⱼ there is at least one Cu point of intersection with the mirror surface (1311) with a surface normal Nᵢⱼ such that Rᵢⱼ is reflected to hit the desired point on the screen (1316), Sᵢⱼ. The Cᵢⱼ points define the mirror surface C.

Finding a solution to Cᵢⱼ for all Rᵢⱼ provides a surface that theoretically addresses the correction and transport issues of the problem.

To heuristically address the focus issue, the mirror surface should be placed as close to the screen surface as possible without causing self-shadowing or intersecting the screen surface. To correctly address the focus issue, it is desirable to substitute the ray model with a light-cone model.

A standard numerical solution can be found, for example:
1 Choose an initial point on the mirror surface, Cₘₙ.
2 Calculate the Normal at Cₘₙ, Nₘₙ.
3 Calculate the tangents at Cₘₙ, e.g. T^{x}ₘₙ and T^{y}ₘₙ.
4 Take incremental steps along the tangents, to give the neighboring points in C.

Repeat from step 2 until done.

Light-Cone Model

Light at the exit of the light engine to the optimal focal point forms a cone (see FIG. 15, for example). At the base of the cone is the (typically circular) cross section that matches the exit point of the light engine. This exit point is normally at an optical lens. The tip of the cone rests at the focal point. Every coordinate will have a slightly different light cone. The focal point represents the total light for a particular coordinate converging on a point. Beyond the focal point the light will again diverge, producing an inverted light cone that reaches to infinity.

Typically, the mirror surface, C, will intersect the light cone before the focal point. Therefore the cross section will have area and, where there is curvature in the mirror surface, the normal of the surface can vary over that area. This results in the light being reflected differently over the intersecting area, thus changing the focal point (or even causing the light to never converge). The light cone model finds a surface such that the reflected light from every light cone, Lᵢⱼ, converges at the desired point on the screen surface, Sᵢⱼ. It is also possible to place the mirror surface such that it intersects the light cone at or after the focal point, in which case the mirror must still refocus the light cone so that it converges again at the screen.

Optimization

The previous models are theoretical ideals and depending on the characteristics of the light engine, screen shape, and component arrangement, may not have a workable solution. In these (the more common) instances, all mirror surfaces will produce some amount of error between the desired results and the actual results. An optimization approach can be used to find a suitable surface by minimizing a particular error measurement.

Several optimization algorithms were explored, but gradient descent works for well chosen initial conditions and carefully managed learning parameters. Other methods, such as Cross Entropy (CE) produce similar results. Support Vector Machines and similar approaches were found to be less suited to the error space.

For simplicity and reduced numerical processing load, an optimizer on the ray model can produce adequate results. The fundamental error metric is the Euclidean distance between the desired point and the actual intersection point on the screen (or the nearest point on the ray to the desired point on the screen if the ray does not intersect with the screen). However, minimizing Euclidean distance for individual coordinates can produce an overall non-uniform error, which can be noticeable to the human eye. Therefore a further consideration can incorporate the first derivative of the distance, decomposed into component parts. This produces a more even overall error, which makes the error less perceivable (as in FIG. 14).

As previously mentioned, the heuristic approach to mirror placement allows an acceptable mirror to be generated. This result can be achieved by fixing a point on the mirror such that the mirror is as close to the screen surface as possible without causing self-shadowing or intersecting with the screen. The point to be fixed is arbitrary, although the center of the mirror is a good starting point. The location that it is fixed to can be found through an optimization of the mirror results with the two conditions (no self-shadowing or intersection).

Optimization on the light-cone model produces the most ideal results. The error metric incorporates additional terms: the size and shape of the area of intersection with the screen. Under ideal conditions the area of intersection for each projected pixel exactly matches the (usually rectangular) area of the screen that the pixel should occupy. In the case of a spherical screen, the ideal pixel area is the projection of a rectangle on the cylinder. The dimensions of the ideally

projected pixel will be

$$\frac{{screen}_{height}}{{resolution}_{vertical}}$$

tall and

$$\frac{{screen}_{arclength}}{{resolution}_{horizontal}}$$

wide along the arc (arc length).

A good choice for the error metric is to take into consideration:
the first derivative of the distance between center points of projected areas;
the difference in size and shape between the projected pixel and the ideally projected pixel; and
the amount of the projected pixel that lies outside the ideally projected pixel.

The mirror surface can be approximately described using a polynomial representation, a spline patch representation, a grid mesh representation.

A mirror whose design is derived as described above can be produced in any known manner. The representation of the mirror design may be in any format that a manufacturer typically uses to produce a mirror, such as standard CAD formats (e.g., IGES) which support one of the previously described representations (such as spline patches, for example) as a surface description.

It is desirable that this process produces mirrors that are classified as front (or first) surfaced mirrors, that is, they have the reflective coating on the front of the material. However, in certain instances rear-surfaced mirror manufacture may suffice.

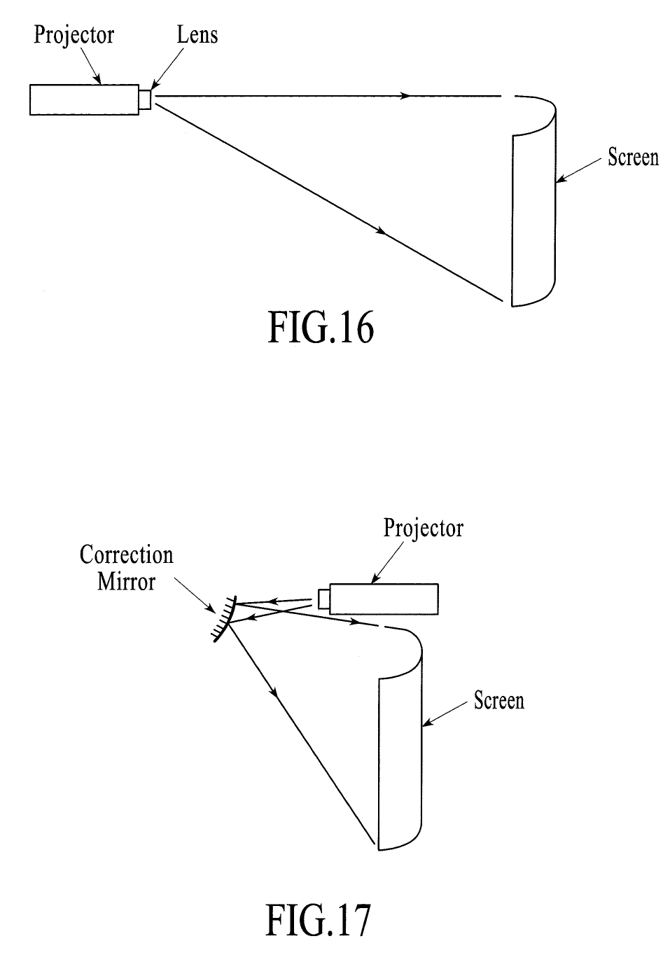

FIGS. 16-17 are diagrams of alternative embodiments that include front projection. FIG. 16 shows a projector (also referred to as a light engine) projecting onto a curved screen. Optical geometric correction in this embodiment is performed by a specially designed lens. FIG. 17 shows a projector (also referred to as a light engine) projecting onto a correction mirror, whose shape can be derived by the process given above, which in turn reflects onto a curved screen.

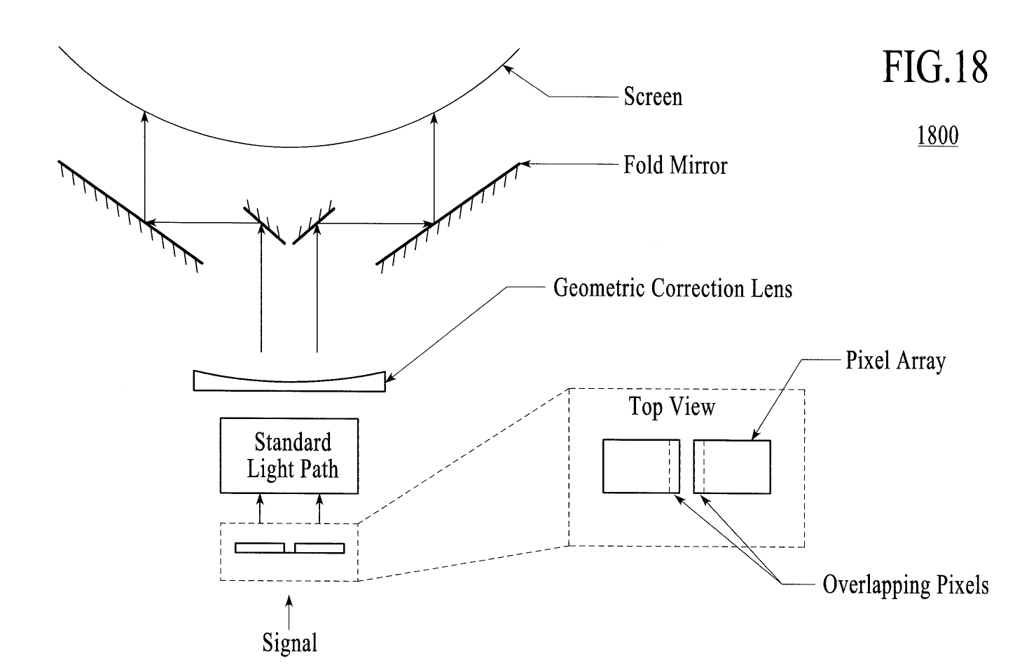

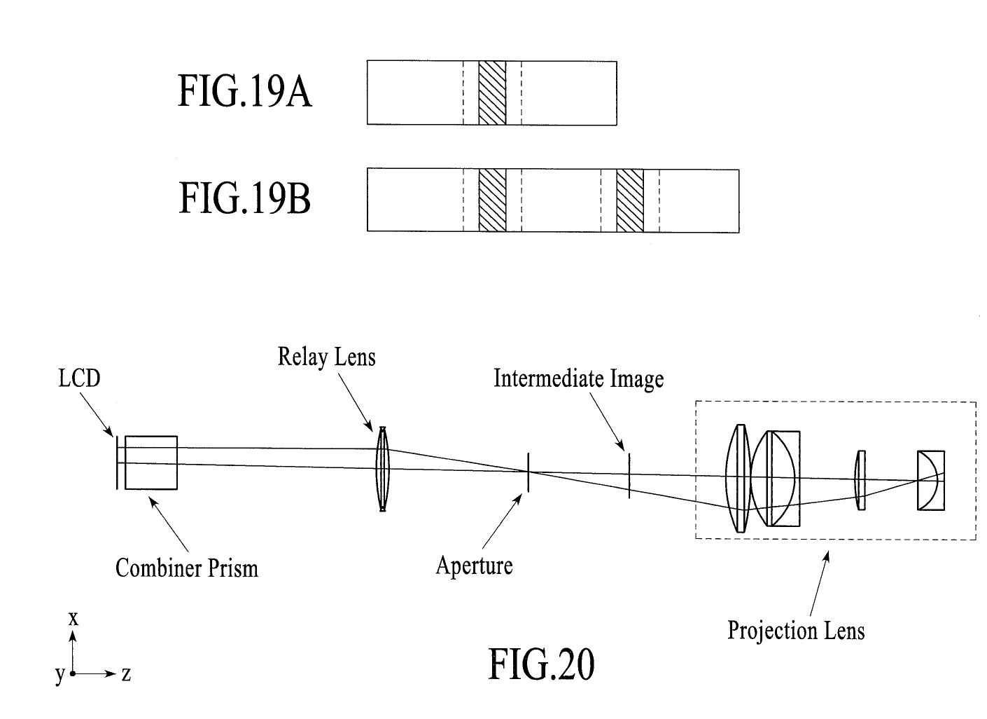

FIGS. 18-19 are block diagrams of yet another alternative embodiment of a curved rear screen projection system. FIG. 18 is a block diagram of a curved rear screen projection system 1800, according to an embodiment. A signal is fed into the system 1800, which is then geometrically corrected as previously described. In the embodiment illustrated, the image source is split into a number of tiles, which then map to a pixel panel arrangement (as described further below with reference to FIGS. 19A and 19B). Where edge blending is used, a percentage of the edge regions of each tile are repeated, effectively being drawn twice on two separate edge regions that are eventually overlapped and combined. The processor 604 can be used to create the duplicate image overlap regions. Once the image has been displayed on the pixel panel arrangement, the light passes through the optical path of the projection device, before being projected through the geometric correction lens. Here the pixels are manipulated to map to the desired shape of the screen.

Once the light has passed through the lens, a combination of optical mirrors is used to alter the light path. The exact arrangement and placement of the mirrors reflects the physical gap between the tiled pixel arrays in the pixel panel arrangement. Various combinations of pixel arrays, overlapping regions and mirror placements can be used depending upon the final screen surface.

The light path is projected onto an optical fold mirror (or arrangement of plural fold mirrors) so that the throw distance of the image source can be packaged into a smaller area. Correction mirrors can be used to geometrically correct the image to map to the screen surface. This method also reduces the angle of incidence when the light path intersects with the screen surface and hence achieves an improved uniform intensity. Blending of the optical light paths can be either achieved through a reduction of the light passing the pixel arrangement system, or optical masking located in the light path, such as on the lens, on the mirror systems or otherwise located in the light path. Each of the individual light paths appears on the screen as a seamless image.

The display screen can be cylindrical, spherical, conical, toroidal or combination of the aforementioned shapes. The radius of the screen can be varied for differing device models and can be defined for different aspect ratios (including, but not limited to 4:3, 16:9, 16:10, 2.35:1, 2.39:1). FIG. 18 shows an embodiment that corrects using an optical lens, however, alternate embodiments can use correction mirrors (as in 1100 of FIG. 11) and digital processors (as in 604 of FIG. 6), or any combination of these elements.

FIGS. 19A and 19B are diagrams illustrating examples of pixel panel arrangements according to various embodiments. FIG. 19A shows two separate pixel tiles located on one physical device. The hatched area indicates a physical gap where mirror placement can direct the light into two separate paths. The dotted vertical line in the same figure indicates an area where there is a repeated area of the image source. This repeated area is overlapped and blended to produce a seamless end image. FIG. 19B illustrates a similar technique, but in this instance, three individual tiled areas are present. Here, the hatched area indicates an area where no pixels are produced, but enables a mirror arrangement later in the light path to divert the individual image sources. In the center panel, repeated areas are on both sides of the pixel tile, as both edges are overlapped and blended with each adjacent pixel tile.

FIGS. 20-22 are diagrams illustrating yet another embodiment that includes distortion cancelling projection optics. Optical distortion created when an image is projected onto a cylindrical surface is reduced by the arrangements shown. Between an object to be projected and a projection lens, an intermediate, real image is created in such a way that it has pincushion distortion. The pincushion distortion cancels the distortion caused by display of a planar image onto a non-planar surface. FIG. 20 is a diagram of a model of a lens arrangement according to an embodiment. Components of the lens arrangement include a lens (or group of lenses) and an aperture. They are chosen and correctly positioned to create the proper pincushion distortion that will cancel to the greatest extent possible, the barrel distortion produced by projecting onto a curved screen. The optics arrangement includes a projection lens that is itself made up of several lenses. A relay lens is on the opposite side of the intermediate image and an aperture with respect to the projection lens. A combiner prism is between a display (in this case a liquid crystal display (LCD)) and the relay lens.

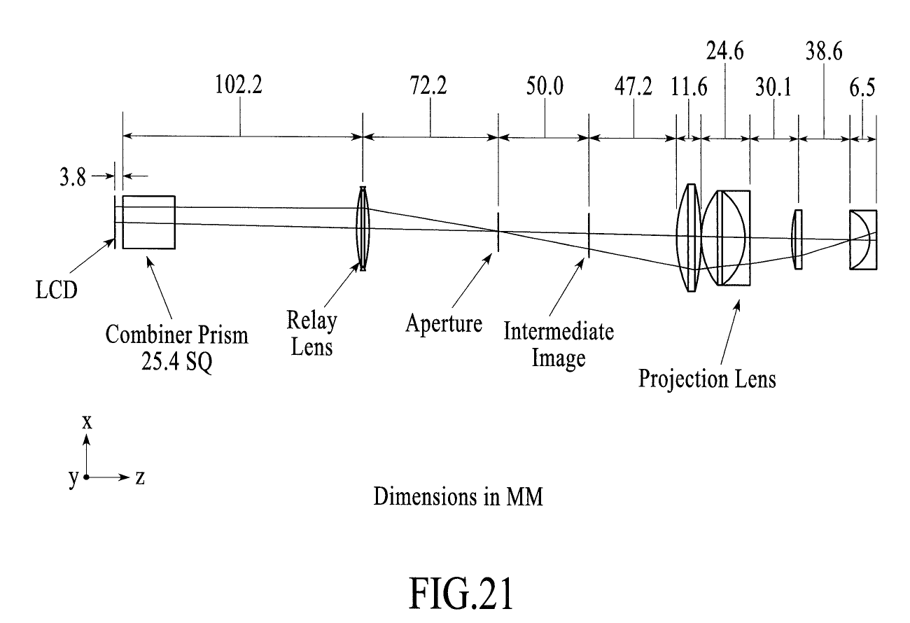

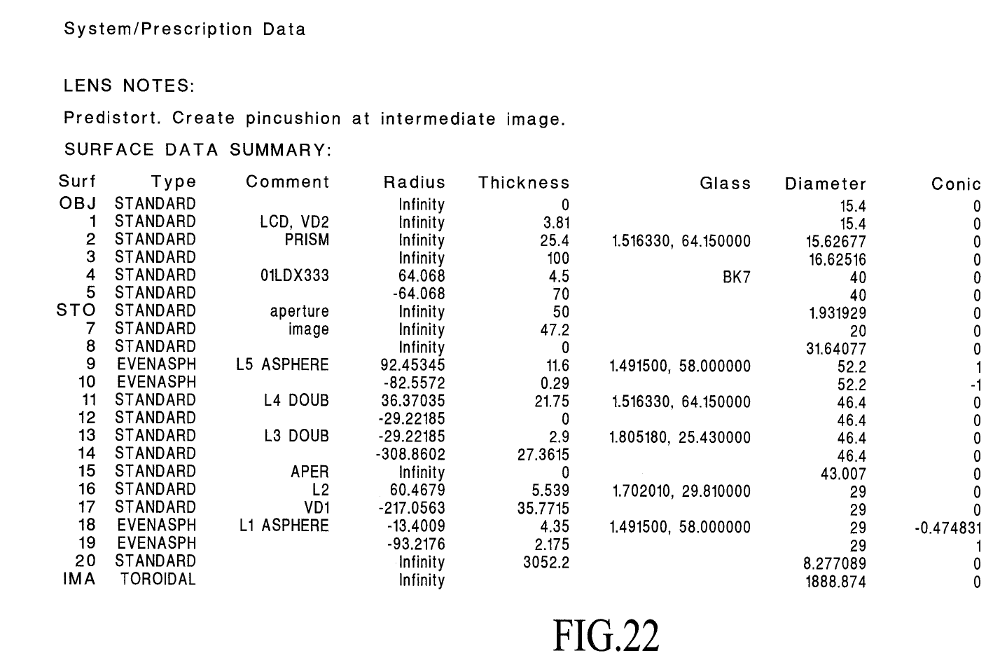

FIG. 21 is a schematic diagram of an embodiment of a lens arrangement specifying dimensions. According to an embodiment, optics are designed to create the right amount and shape of pincushion distortion to cancel the undesirable barrel distortion in the displayed image. FIG. 21 is a Zemax model created using Zemax optical analysis software. FIG. 22 is a Zemax analysis of the model of FIG. 21. The analysis illustrated in FIG. 22 indicates that the barrel distortion will be reduced from 12% to about 3.3% in this model. Further reduction is possible with a multi-element lens or a lens with a more optimal curvature.

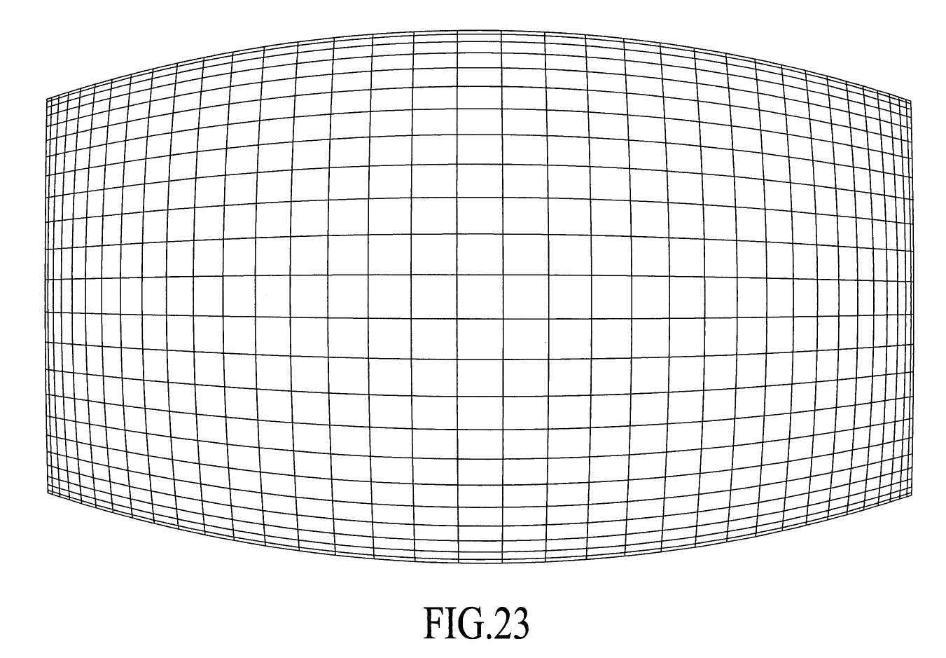

FIG. 23 illustrates yet another embodiment where the geometric correction mapping function is calculated and the panel's physical shape is changed accordingly to reflect the geometric correction map. Here, pixels are not remapped within a rectangular grid as per existing methods, but the grid of pixels are reshaped during the pixel panel manufacturing process in order that the panel has the correct geometry. This shape is then projecting through existing projector optics to provide a correct image on the curved screen display device.

FIG. 23 shows an example of the shape of the pixel panel in order to project onto a rear curved surface, concave to the viewer. Note that pixels at the outer edges are shown to be smaller in order for the pixel sizes to be correct at the screen surface. Pixels in the center of the panel are larger and more rectangular due to lesser distortion occurring in the center and distance that the light ray needs to be travel to hit the screen surface.

Embodiments described herein include a curved screen display system, comprising: a processor coupled to receive standard video content; a light engine coupled to the processor; and an optics array positioned to receive a projected image output from the light engine, the optics array comprising at least one correction mirror configured to reflect the projected image onto a non-planar display screen accurately such that pixels of the projected image are remapped to the non-planar display screen.

In an embodiment, the processor is configurable to geometrically correct the standard video content for display on the non-planar display screen.

In an embodiment, the optics array further comprises at least one fold mirror positioned to receive the projected image output from the light engine and to reflect the projected image onto the at least one correction mirror.

An embodiment further comprises a non-planar display screen selected from a group comprising: a cylindrical screen; a toroidal screen; and a spherical screen.

Embodiments described herein further include a method, comprising: receiving a video signal comprising standard video content; performing a digital correction process on the standard video content to generate corrected standard video content, comprising remapping pixels of the standard video content to a non-planar display screen; and projecting the corrected standard video content, comprising projecting onto at lest one correction mirror designed to reflect a video image onto the non-planar display screen undistorted.

In an embodiment, projecting further comprises projecting onto at lest one fold mirror.

In an embodiment, the standard video content comprises computer display content, TV content, DVD content, Blu-Ray content, HD-DVD content, and game console content.

In an embodiment, the digital correction process comprises pixel remapping dependent on at least one of: light engine location; light engine lens configuration, and non-planar display screen surface configuration.

An embodiment further comprises generating a design for the at least one correction mirror, wherein generating comprises defining a mathematical model of the system such that given a non-planar display screen surface, S, and a light engine at location p, a surface, C, can be found such that light is correctly reflected from the light engine back onto the non-planar display screen surface.

An embodiment further comprises: defining a ray mathematical model, wherein a light engine at location p is able to generate a light ray Rᵢⱼ whose source is p and which represents the light engine space coordinates (i,j); and finding Cᵢⱼ for all Rᵢⱼ.

An embodiment further comprises: defining a light cone mathematical model, wherein a surface, C, of the at least one correction mirror surface intersects a light cone at a location selected from a group comprising, before a focal point, at a focal point, or after a focal point; and finding a surface such that reflected light from every light cone, Lᵢⱼ, converges in proximity to a desired point on a surface, Sᵢⱼ of the non-planar screen.

An embodiment further comprises calculating a surface of the at least one correction mirror as close to the screen surface as possible without causing the at least one correction mirror to self-shadow and without causing the at least one correction mirror to intersect the screen surface.

An embodiment further comprises optimizing the mathematical model using an optimization algorithm.

An embodiment further comprises describing a designed correction mirror using a representation selected from a group comprising a polynomial representation, a spline patch representation, and a mesh representation.

In an embodiment, the at least one correction mirror is a front surfaced mirror.

In an embodiment, the at least one correction mirror is a rear surfaced mirror.

Embodiments described herein include a correction mirror produced according to the methods described herein.

Embodiments described herein further include a curved screen display system, comprising: a processor coupled to receive standard video content; a light engine coupled to the processor; and an optics array positioned to receive a projected image output from the light engine, the optics array comprising at least one correction mirror configured to reflect the projected image onto a non-planar display screen accurately such that pixels of the projected image are remapped to the non-planar display screen, wherein the at least one correction mirror is produced according to the methods described herein.

Embodiments described herein further include a computer-readable medium storing instructions that when executed by a processor, cause a curved screen display method to be performed by a curved screed display system, the method comprising: receiving a video signal comprising standard video content; performing a digital correction process on the standard video content to generate corrected standard video content, comprising remapping pixels of the standard video content to a non-planar display screen; and projecting the corrected standard video content, comprising projecting onto at lest one correction mirror designed to reflect an undistorted video image onto the non-planar display screen.

Embodiments described herein further include a computer-readable medium storing instructions that when executed by a processor, cause a curved screen display method to be performed by a curved screed display system, the method comprising: receiving a video signal comprising standard video content; and performing a digital correction process on the standard video content to generate corrected standard video content, comprising remapping pixels of the standard video content to a non-planar display screen.

Embodiments described herein further include a computer-readable medium storing instructions that when executed by a processor, generate a design for a correction mirror, wherein generating comprises defining a mathematical model of the system such that given a non-planar display screen surface, S, and a light engine at location p, a surface, C, can be found such that light is correctly reflected from the light engine back onto the non-planar display screen surface.

Aspects of the curved screen display systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various circuits implicitly or explicitly disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the curved screen display systems and methods is not intended to be exhaustive or to limit the systems and methods to the precise form disclosed. While specific embodiments of, and examples for, the systems and methods are described herein for illustrative purposes, various equivalent modifications are possible within the scope of the curved screen display systems and methods, as those skilled in the relevant art will recognize. The teachings of the curved screen display systems and methods provided herein can be applied to other processing systems and methods, not only for the systems and methods described above.

The elements and acts of the various embodiments described above can be combined to provide further embodiments. These and other changes can be made to the curved screen display systems and methods in light of the above detailed description.

What is claimed is:

1. A curved screen display system, comprising:
a processor coupled to receive standard video content;
a light engine coupled to the processor; and
an optics array positioned to receive a projected image output from the light engine, the optics array comprising at least one correction mirror configured to reflect the projected image onto a non-planar display screen accurately such that pixels of the projected image are remapped to the non-planar display screen.

2. The system of claim 1, wherein the processor is configurable to geometrically correct the standard video content for display on the non-planar display screen.

3. The system of claim 1, wherein the optics array further comprises at least one fold mirror positioned to receive the projected image output from the light engine and to reflect the projected image onto the at least one correction mirror.

4. The system of claim 1, further comprising a non-planar display screen selected from a group comprising:
a cylindrical screen;
a toroidal screen; and
a spherical screen.

5. A curved screen display method, comprising:
receiving a video signal comprising standard video content;
performing a digital correction process on the standard video content to generate corrected standard video content, comprising remapping pixels of the standard video content to a non-planar display screen; and
projecting the corrected standard video content, comprising projecting onto at lest one correction mirror designed to reflect a video image onto the non-planar display screen undistorted.

6. The method of claim 5, wherein projecting further comprises projecting onto at lest one fold mirror.

7. The method of claim 5, wherein the standard video content comprises computer display content, TV content, DVD content, Blu-Ray content, HD-DVD content, and game console content.

8. The method of claim 5, wherein the digital correction process comprises pixel remapping dependent on at least one of: light engine location; light engine lens configuration, and non-planar display screen surface configuration.

9. The method of claim 5, further comprising generating a design for the at least one correction mirror, wherein generating comprises defining a mathematical model of the system such that given a non-planar display screen surface, S, and a light engine at location p, a surface, C, can be found such that light is correctly reflected from the light engine back onto the non-planar display screen surface.

10. The method of claim 9, further comprising:
defining a ray mathematical model, wherein a light engine at location p is able to generate a light ray Rᵢⱼ whose source is p and which represents the light engine space coordinates (i,j); and
finding Cᵢⱼ for all Rᵢⱼ.

11. The method of claim 9, further comprising:
defining a light cone mathematical model, wherein a surface, C, of the at least one correction mirror surface intersects a light cone at a location selected from a group comprising, before a focal point, at a focal point, or after a focal point; and
finding a surface such that reflected light from every light cone, Lᵢⱼ, converges in proximity to a desired point on a surface, Sᵢⱼ of the non-planar screen.

12. The method of claim 5, further comprising calculating a surface of the at least one correction mirror as close to the screen surface as possible without causing the at least one correction mirror to self-shadow and without causing the at least one correction mirror to intersect the screen surface.

13. The method of claim 9, further comprising optimizing the mathematical model using an optimization algorithm.

14. The method of claim 9, further comprising describing a designed correction mirror using a representation selected from a group comprising a polynomial representation, a spline patch representation, and a mesh representation.

15. The method of claim 9, wherein the at least one correction mirror is a front surfaced mirror.

16. The method of claim 9, wherein the at least one correction mirror is a rear surfaced mirror.

17. A correction mirror produced according to the method of claim 9.

18. A curved screen display system, comprising:
a processor coupled to receive standard video content;
a light engine coupled to the processor; and
an optics array positioned to receive a projected image output from the light engine, the optics array comprising at least one correction mirror configured to reflect the projected image onto a non-planar display screen accurately such that pixels of the projected image are remapped to the non-planar display screen, wherein the at least one correction mirror is produced according to the method of claim 9.

19. A computer-readable medium storing instructions that when executed by a processor, cause a curved screen display method to be performed by a curved screed display system, the method comprising:
receiving a video signal comprising standard video content;
performing a digital correction process on the standard video content to generate corrected standard video content, comprising remapping pixels of the standard video content to a non-planar display screen; and
projecting the corrected standard video content, comprising projecting onto at lest one correction mirror designed to reflect an undistorted video image onto the non-planar display screen.

20. A computer-readable medium storing instructions that when executed by a processor, cause a curved screen display method to be performed by a curved screed display system, the method comprising:
receiving a video signal comprising standard video content; and
performing a digital correction process on the standard video content to generate corrected standard video content, comprising remapping pixels of the standard video content to a non-planar display screen.

21. A computer-readable medium storing instructions that when executed by a processor, generate a design for a correction mirror, wherein generating comprises defining a mathematical model of the system such that given a non-planar display screen surface, S, and a light engine at location p, a surface, C, can be found such that light is correctly reflected from the light engine back onto the non-planar display screen surface.
